(19) United States
(12) Patent Application Publication
(10) Pub. No.: US 2008/0249875 A1
(43) Pub. Date: Oct. 9, 2008

(54) DISFAVORING QUALIFIED ADVERTISEMENTS IN CONTEXTUAL ADVERTISEMENT

(75) Inventors: JOONGOO LEE, DAEJEON (KR); JONGMAN KOO, SEOUL (KR)

Correspondence Address: KNOBBE MARTENS OLSON & BEAR LLP, 2040 MAIN STREET, FOURTEENTH FLOOR, IRVINE, CA, 92614, US

(73) Assignee: NHN CORPORATION, SEONGNAM-SI (KR)

(21) Appl. No.: 12/098,076

(22) Filed: Apr. 4, 2008

(30) Foreign Application Priority Data
Apr. 4, 2007 (KR) 10-2007-0033468

(51) Int. Cl. G06Q 30/00; G06F 17/30

(52) U.S. Cl. 705/14; 707/7; 707/E17.033

(57) ABSTRACT

Disclosed is a method of formulating a list of advertisements in an advertisement service. The method comprises analyzing a web content so as to identify a plurality of keywords therefrom, and retrieving data of a plurality of advertisements, each of which is associated with one of the plurality of keywords and is presently subject to an advertising service. The method further comprises processing the data of the plurality of advertisements so as to identify two or more advertisements that are associated with the same advertiser and further processing data of the two or more advertisements so as to identify at least one qualified advertisement for disfavoring in the advertising service. The method further comprises ordering at least part of the plurality of advertisements to display along with the web content such that the at least one qualified advertisement is disfavored in the ordering.

### CROSS-REFERENCE TO RELATED APPLICATION

This application claims priority to and the benefit of Korean Patent Application No. 10-2007-0033468, filed on Apr. 4, 2007, the entire disclosure of which is incorporated herein by reference.

### BACKGROUND

1. Field

The present disclosure relates to Internet advertising, and more particularly, to disfavoring qualified advertisements in contextual advertising.

2. Discussion of the Related Technology

In current advertisement services, a contextual advertising in which contents of a web document read by a user are distinguished and advertisements corresponding to the distinguished contents are provided to the user has been actively distributed. The contextual advertising is commercially gaining attention in that advertisements interested in by the user are distinguished using the web document currently read by the user, and the distinguished advertisements are naturally provided to the user without annoying the user.

The foregoing discussion is to provide general background information, and does not constitute an admission of prior art.

### SUMMARY

One aspect of the invention provides a method of formulating a list of advertisements in an advertisement service, which comprises: analyzing a web content so as to identify a plurality of keywords therefrom; retrieving data of a plurality of advertisements, each of which is associated with one of the plurality of keywords and is presently subject to an advertising service; processing the data of the plurality of advertisements so as to identify two or more advertisements that are associated with the same advertiser; further processing data of the two or more advertisements so as to identify at least one qualified advertisement for disfavoring in the advertising service; and ordering at least part of the plurality of advertisements to display along with the web content such that the at least one qualified advertisement is disfavored in the ordering.

In the foregoing method, each advertisement data may comprise at least one selected from the group consisting of a keyword, information of an advertiser, a web address that is to be anchor-tagged, and a description of the advertisement to be displayed with an anchor tag of the web page. Two or more advertisements may be identified as associated with the same advertiser when said two or more advertisements have an identical description. Two or more advertisements may be identified as associated with the same advertiser when said two or more advertisements have a common portion in their web addresses. Two or more advertisements may be identified as associated with the same advertiser when said two or more advertisements have an identical web address.

Still in the foregoing method, further processing may comprise analyzing the keywords of the two or more advertisements. At least one of the two or more advertisements may be identified as qualified for disfavoring when at least two keywords of the two or more identified advertisements belong to a single category among a plurality of predetermined categories. At least one of the two or more advertisements may be identified as qualified for disfavoring when at least two keywords of the two or more identified advertisements are synonyms. At least one of the two or more advertisements may be identified as qualified for disfavoring when two keywords of the two or more identified advertisements is determined as related from a statistical processing using data of appearances of keywords in web contents.

Yet in the foregoing method, the at least one qualified advertisement may be disfavored based on a disfavoring factor computed using the number of advertisements having an identical description among the plurality of advertisements, wherein the higher the number is, the higher the disfavoring factor is. The at least one qualified advertisement may be disfavored based on a disfavoring factor computed using the number of advertisements having a common portion in their web addresses among the plurality of advertisements, wherein the higher the number is, the higher the disfavoring factor is. The at least one qualified advertisement may be disfavored based on a disfavoring factor computed using the number of advertisements having an identical web address among the plurality of advertisements, wherein the higher the number is, the higher the disfavoring factor is. The at least one qualified advertisement may be disfavored based on a disfavoring factor computed using the number of advertisements having an identical keyword among the plurality of advertisements, wherein the higher the number is, the higher the disfavoring factor is. The at least one qualified advertisement may be disfavored based on a disfavoring factor computed using the number of advertisements having keywords that are synonyms among the plurality of advertisements, wherein the higher the number is, the higher the disfavoring factor is. The at least one qualified advertisement may be disfavored based on a disfavoring factor computed using the number of advertisements having keywords that belong to a single category among a plurality of predetermined categories among the plurality of advertisements, wherein the higher the number is, the higher the disfavoring factor is. The at least one qualified advertisement may be disfavored based on a disfavoring factor computed using the number of advertisements of the same advertiser among the total advertisements that are presently subject to the advertising service, wherein the higher the number is, the higher the disfavoring factor is.

Further in the foregoing method, ordering at least part of the plurality of advertisements may comprise computing a ranking index for each of at least part of the plurality of advertisements; and sorting at least part of the plurality of advertisements using the ranking index. Computing the ranking index may comprise using a formula comprising a favoring factor and a disfavoring factor, wherein the at least one qualified advertisement may have a non-zero value of the disfavoring factor in computing the ranking index. The favoring factor may comprise at least one selected from the group consisting of a cost-per-click for each advertisement, wherein the higher the cost-per-click is, the higher favoring factor is. The favoring factor may comprise at least one selected from the group consisting of a cost-per-click for each advertisement, the number of click-throughs for each advertisement for a time period, wherein the higher the number of click-throughs, the higher the favoring factor is.

Further still in the foregoing method, the favoring factor may comprise at least one selected from the group consisting of a cost-per-click for each advertisement, relatedness of a advertisement content of each advertisement to a keyword of the advertisement, wherein the more the relatedness is, the higher the favoring factor is. Ordering at least part of the plurality of advertisements may comprise: computing a ranking index for each of at least part of the plurality of advertisements using at least one ranking factor selected from the group consisting of a cost-per-click for each advertisement, the number of click-throughs for each advertisement for a time period, relatedness of a advertisement content of each advertisement to a keyword of the advertisement; and adjusting the ranking index using a disfavoring factor for the at least one qualified advertisement.

Another aspect of the invention provides a system for formulating a list of advertisements in an advertisement service, the method comprising: means for identifying a plurality of keywords therefrom; means for providing data of a plurality of advertisements, each of which is associated with one of the plurality of keywords and is presently subject to an advertising service; means for processing the data of the plurality of advertisements so as to identify two or more advertisements that are associated with the same advertiser and further processing data of the two or more advertisements so as to identify at least one qualified advertisement for disfavoring in the advertising service; and means for ordering at least part of the plurality of advertisements to display along with the web content such that the at least one qualified advertisement is disfavored in the ordering.

An aspect of the invention provides a system and method for generating an advertisement list which suppress the so-called ‘rich get richer, poor get poorer’ phenomenon concerning advertisement display, in which advertisement information of small and medium advertisers is difficult to be displayed to users, thereby preventing advertisement information of a large advertiser from being exclusively displayed in an advertisement list regardless of contents of a content page for the purpose of an display to users, and thus enhancing advertisement display opportunities of the small and medium advertisers.

Another aspect of the invention provides a system and method for generating an advertisement list which appropriately apply a penalty to the advertisement information of the large advertiser, thereby preventing reverse discrimination against the advertisement information of the large advertiser from occurring due to the penalty.

A further aspect of the invention provides a system and method for generating an advertisement list which divide advertisers according to relevance between keywords, thereby preventing characteristics of advertisement groups from being wholly undistinguished due to a large advertiser having relatively many advertisements.

Still another aspect of the invention provides a system and method for generating an advertisement list which precisely identify an advertiser enabling a plurality of advertisement information, which has a relatively high relevance between keywords, to be included in the advertisement list as the large advertiser based on the relevance between the keywords of the advertisement information included in the advertisement list, thereby reliably applying a penalty with respect to the large advertiser.

According to an aspect of the present invention, there is provided a method for generating an advertisement list, the method comprising: combining keywords associated with each other to generate a plurality of keyword groups in a keyword list; determining whether keyword-related advertisement information associated with respective keywords included in a content page corresponds to advertisement information of a large advertiser; determining presence or absence of a relation between keywords associated with the advertisement information of the large advertiser, based on the keyword list, when the keyword-related advertisement information corresponds to the advertisement information of the large advertiser; applying a predetermined penalty to at least one of the advertisement information of the large advertiser according to the presence or absence of the relation to thereby update a ranking grade having been applied to the advertisement information of the large advertiser; and arranging the keyword-related advertisement information in the advertisement list based on the updated ranking grade.

In this instance, the determining whether keyword-related advertisement information corresponds to advertisement information may include determining that the keyword-related advertisement information corresponds to the advertisement information of the large advertiser, when address information or content information of the keyword-related advertisement information matches address information or content information of the advertisement information of the large advertiser by more than a predetermined degree.

Also, the determining may include determining that the relation between the keywords is present when the keywords are included in an identical group of the keyword list, otherwise determining that the relation between the keywords is absent.

Also, the applying may include counting a number of keywords stored in a database in association with the large advertiser; setting the predetermined penalty based on the counted number of the keywords; and applying the set penalty to the ranking grade having been applied to the advertisement information of the large advertiser to thereby update the ranking grade.

Also, the method for generating the advertisement list may further comprise controlling a predetermined contextual advertising engine so that the advertisement list and the content page are provided to a user.

Also, the combining may include associating the keywords with each other using at least one of a dictionary meaning, a category, and a predetermined logic; combining the associated keywords to generate a plurality of keyword groups; and forming the generated plurality of keyword groups into the keyword list.

Also, the logic may include acquiring keyword statistical information using the keywords included in the content page; standardizing the acquired keyword statistical information; and measuring relevance between the keywords based on the standardized keyword statistical information.

According to another aspect of the present invention, there is provided a system for generating an advertisement list, the system comprising: a keyword list generating unit for combining keywords associated with each other to generate a plurality of keyword groups in a keyword list; an advertisement information determining unit for determining whether keyword-related advertisement information associated with respective keywords included in a content page corresponds to advertisement information of a large advertiser; a determination unit for determining presence or absence of a relation between keywords associated with the advertisement information of the large advertiser, based on the keyword list, when the keyword-related advertisement information corresponds to the advertisement information of the large advertiser; a ranking unit for applying a predetermined penalty to at least one of the advertisement information of the large advertiser according to the presence or absence of the relation to thereby update a ranking grade having been applied to advertisement information of the large advertiser; and an advertisement list forming unit for arranging the keyword-related advertisement information in the advertisement list based on the updated ranking grade.

In this instance, the advertisement information determining unit may determining that the keyword-related advertisement information corresponds to the advertisement information of the large advertiser, when address information or content information of the keyword-related advertisement information matches address information or content information of the advertisement information of the large advertiser by more than a predetermined degree.

Also, the determination unit may determine that the relation between the keywords is present when the keywords are included in an identical group of the keyword list, otherwise may determine that the relation between the keywords is absent.

Also, the ranking unit may include a counting unit for counting a number of keywords stored in a database in association with the large advertiser; a penalty setting unit for setting the predetermined penalty based on the counted number of the keywords; and a ranking updating unit for applying the set penalty to the ranking grade having been applied to the advertisement information of the large advertiser to thereby update the ranking grade. Also, the advertisement list forming unit may control a predetermined contextual advertising engine so that the advertisement list and the content page are provided to a user.

Also, the keyword list generating unit may (1) associate the keywords with each other using at least one of a dictionary meaning, a category, and a predetermined logic, (2) combine the associated keywords to generate a plurality of keyword groups, and (3) form the generated plurality of keyword groups into the keyword list. Also, the logic may include (1) acquiring keyword statistical information using the keywords included in the content page; (2) standardizing the acquired keyword statistical information; and (3) measuring relevance between the keywords based on the standardized keyword statistical information.

### BRIEF DESCRIPTION OF THE DRAWINGS

The above and other aspects of the present invention will become apparent and more readily appreciated from the following detailed description of certain embodiments of the invention, taken in conjunction with the accompanying drawings of which:

FIG. 1 is a schematic diagram illustrating an operation of a system for generating an advertisement list according to an embodiment of the present invention;

FIG. 2 is a block diagram illustrating the system for generating the advertisement list illustrated in FIG. 1;

FIG. 3 is a diagram illustrating an example of a keyword list in the system for generating the advertisement list according to an embodiment of the present invention;

FIG. 4 is a block diagram illustrating an interior configuration of a ranking unit illustrated in FIG. 2;

FIGS. 5A and 5B are diagrams illustrating an example of generating an advertisement list in the system for generating the advertisement list according to an embodiment of the present invention;

FIG. 6 is a flowchart illustrating a method for generating an advertisement list according to an embodiment of the present invention;

FIG. 7 is a flowchart illustrating a process where a penalty is applied to advertisement information of a large advertiser according to an embodiment of the invention; and

FIG. 8 is a flowchart illustrating a process where reliability between keywords is measured according to an embodiment of the invention.

### DETAILED DESCRIPTION OF EMBODIMENTS

Reference will now be made in detail to embodiments of the present invention, examples of which are illustrated in the accompanying drawings, wherein like program segments refer to the like elements throughout. Hereinafter, a method and system for generating an advertisement list according to embodiments of the invention will be described in detail with reference to appended drawings.

A contextual advertising (CA, hereinafter referred to as ‘CA’) used throughout the present specification may designate an advertisement provided corresponding to contents of a web document (referred to as ‘content page’ in the present specification) or designate an advertising providing scheme. For example, when a user currently reads a web document dealing with traveling, a predetermined advertisement server supporting the CA may search for advertisement information concerning traveling and display the obtained advertisement information on the web document currently read by the user. In this instance, the advertisement server may check contents of the corresponding web document using keywords composing the web document, that is, keywords included in the content page, or other information of the web document.

For example, when a web document read by the user deals with ‘pension’, an advertisement server supporting the contextual advertising may identify advertisements related with ‘pension’, and display the identified advertisements to the user.

However, in the case where a plurality of keywords related with ‘pension’ are purchased by the large advertiser having a relatively strong purchasing power, the advertisement server may exclusively identify advertisement information of the large advertiser, and thus display only the advertisement information of the large advertiser. As a result, advertisement display opportunities of medium and small advertisers which can afford to purchase a relatively small number of keywords used for the contextual advertising may be inevitably reduced.

In addition, in contextual advertising schemes, only advertisement information of the large advertiser which can afford to purchase a relatively large number of keywords may be displayed regardless of contents of the web document. Specifically, the large advertiser is likely to exclusively obtain advertisement effects by the contextual advertising schemes. Adverse effects caused by misusing the contextual advertising as described above may further cause unreliability concerning the contextual advertising.

Accordingly, there is an urgent need for new advertisement list-generating models which can appropriately apply a penalty to a ranking grade having been applied to the advertisement information of the large advertiser, thereby preventing the advertisement information of the large advertiser from being exclusively displayed, and at the same time preventing reverse discrimination against the advertisement information of the large advertiser from occurring due to the penalty.

As to the method and system for generating the advertisement list according to embodiments of the invention, in the case where advertisement information associated with respective keywords included in the content page corresponds to advertisement information of a large advertiser, when a relation between respective keywords associated with the advertisement information of the large advertiser is present based on a keyword list including a plurality of keyword groups acquired by combining keywords associated with each other, a predetermined penalty may be applied to at least one of the advertisement information of the large advertiser to thereby update a ranking grade having been applied to the advertisement information of the large advertiser, and arrange the keyword-related advertisement information in an advertisement list based on the updated ranking.

As a result, a CA scheme in which the advertisement information of the large advertiser is exclusively obtained and displayed to users regardless of contents of the content page may be solved. Specifically, a ‘rich get richer, poor get poorer’ phenomenon concerning advertisement display may be suppressed, in which advertisement information of small and medium advertisers is difficult to be displayed to users, thereby preventing the advertisement information of the large advertiser from being exclusively displayed in an advertisement list regardless of contents of a content page for the purpose of an display to users, and thus enhancing advertisement display opportunities of the small and medium advertisers.

Also, in the method and system for generating the advertisement list according to embodiments of the invention, a penalty may be appropriately applied to the advertisement information of the large advertiser, thereby preventing reverse discrimination against the advertisement information of the large advertiser from occurring due to the penalty.

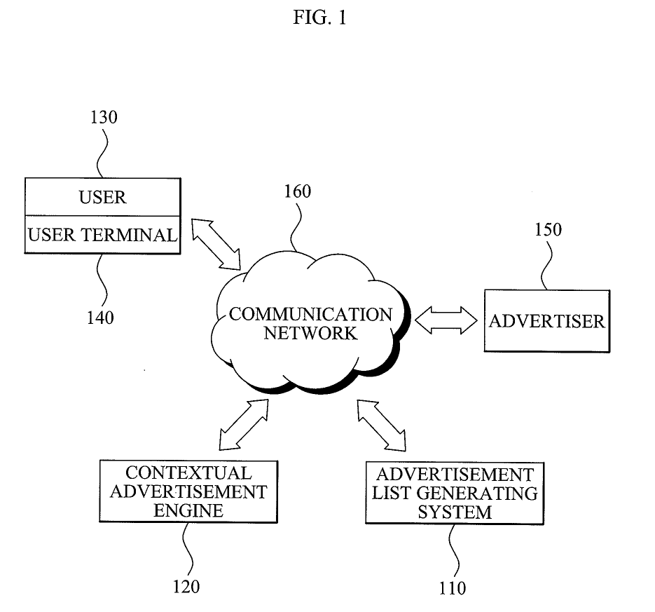

FIG. 1 is a schematic diagram illustrating an operation of a system 110 for generating an advertisement list according to an embodiment of the present invention. Referring to FIG. 1, the system 110 for generating the advertisement list may form the advertisement list intended to be displayed to users depending on contents of a web document, that is, a content page. In particular, the system 110 according to the present embodiment may apply a predetermine penalty to a large advertiser which can afford to purchase a relatively large number of keywords, thereby preventing the advertisement information of the large advertiser from being exclusively displayed to a user 130, and appropriately ensuring display opportunities in which advertisement information of small and medium advertisers is displayed to the user 130. Also, the system 110 according to the present embodiment may appropriately apply the penalty, thereby preventing reverse discrimination against the advertisement information of the large advertiser from occurring due to the penalty.

In this instance, the advertisement list may be acquired by arranging and categorizing much advertisement information, that is, materials for publicity and marketing dealing with the advertisers, commercial items dealt with by the advertisers, and the like according to a predetermined standard. The advertisement list may be provided to the user 130 together with the web document. In particular, according to the present embodiment, the advertisement list may be acquired by identifying keywords from a content page generated in a search engine depending on a search request of the user 130, and using advertisement information extracted from a database corresponding to the identified keywords.

The advertisement list may arrange advertisement information interested in by the user 130, thereby improving advertising effect without annoying the user. The contextual advertising engine 120 may denote an advertisement service server which supports advertisement services by providing advertisement information or an advertisement list, which are searched through concerning the content page currently read by the user 130, to the user 130 together with the content page.

The user 130 may denote an Internet user which posses a user terminal 140 for connection with the contextual advertising engine 120, and is provided with the content page and the advertisement information (advertisement list) via the user terminal 140.

The user terminal 140 may maintain the connection with the system 110 or the contextual advertisement engine 120 via a communication network such as the Internet, and display an advertisement list corresponding to contents of the content page currently read by the user 130 to thereby provide to the user 130.

An advertiser 150 may be an operator of a commercial website which displays its advertisement information corresponding to the contents of the content page to the user 130, and induces the user 130 to select or click on displayed advertisement information.

A communication network 160 may be communication lines used for connection between each of the system 110, the contextual advertisement engine 120, the user 130 via the user terminal 140, and the advertiser 150, and function to exchange information with one another. In this instance, the communication network 160 may include a Public Switched Telephone Network (PSTN), a Packet Switched Data Network (PSDN), a Local Area Network (LAN), an Internet network, a Digital Subscriber Line (xDSL), an Integrated Services Digital Network (ISDN), a mobile communication network, and the like.

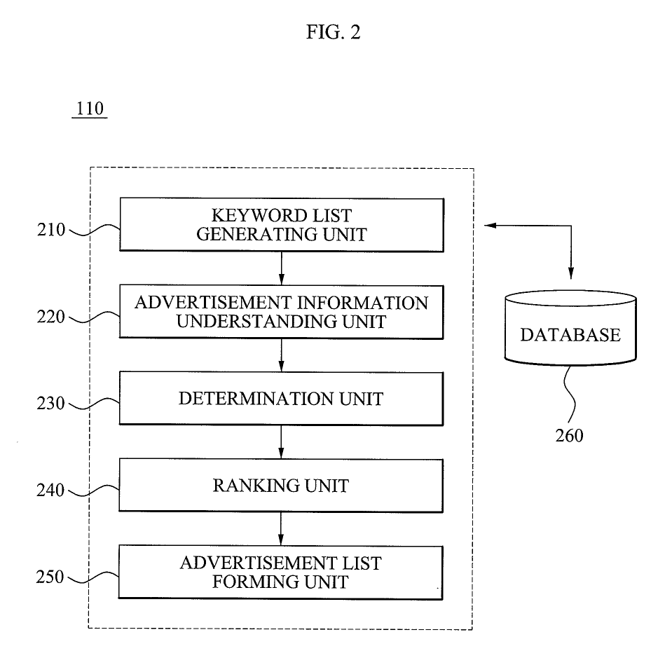

FIG. 2 is a block diagram illustrating the system 110 for generating the advertisement list illustrated in FIG. 1. Referring to FIGS. 1 and 2, the system 110 according to the present embodiment may include a keyword list generating unit 210, an advertisement information determining unit 220, a determination unit 230, a ranking unit 240, an advertisement list forming unit 250, and a database 260.

Prior to description of the system 110 according to the present embodiment, a generation of the content page will be herein described. The content page may be medium information transmitting information to the user 130 via the communication network 160. The content page may be generated by a variety of processing methods. For example, according to the present embodiment, the content page may be generated in response to a search request generated by the user 130 when inputting search keywords in a search site to thereby obtain the content page corresponding to the search keywords.

In general, the generation of the content page corresponding to the search keywords may be performed by a search engine. The search engine may appropriately search for contents interested in by the user 130, and generate the content page using the searched contents. The content page may include keywords which are utilized at the time of distinguishing advertisement information according to the contextual advertising.

The keyword list generating unit 210 may combine keywords associated with each other from among keywords included in the content page to thereby generate a plurality of keyword groups in a keyword list. Specifically, the keyword list generating unit 210 may (1) associate the keywords with each other using at least one of a dictionary meaning, a category, and a predetermined logic, (2) combine the associated keywords to generate a plurality of keyword groups, and (3) form the generated plurality of keyword groups into the keyword list.

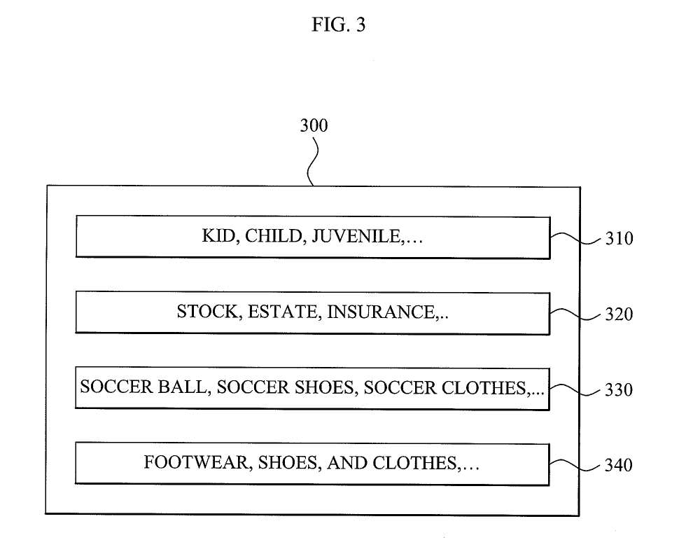

FIG. 3 is a diagram illustrating an example of a keyword list in the system for generating the advertisement list according to embodiments of the present invention. Referring to FIG. 3, an operation of the keyword list generating unit 210 illustrated in FIG. 2 will be herein described in detail. The keyword list generating unit 210 may combine keywords associated with each other from among keywords included in the content page acting as a single keyword group to thereby generate a plurality of keyword groups 310, 320, 330, and 340. In this instance, the keyword list generating unit 210 may associate the keywords with each other using at least one of the dictionary meaning, the category, and the predetermined logic to thereby generate the plurality of keyword groups 310, 320, 330, and 340.

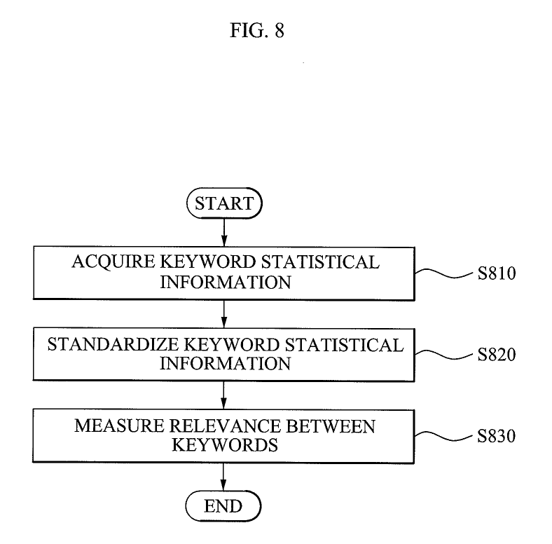

For example, the keyword list generating unit 210 may combine keywords such as ‘kid’, ‘child’, and ‘juvenile’, whose dictionary meaning are similar as a single keyword group 310, to thereby generate the combined keyword group 310 in the keyword list 300. Also, the keyword list generating unit 210 may combine keywords such as ‘stock’, ‘estate’, and ‘insurance’, each which is included in the same category, to thereby generate the combined keyword group 320 in the keyword list 300. Also, the keyword list generating unit 210 may combine keywords such as ‘soccer ball’, ‘soccer shoes’, and ‘soccer clothes’, which are associated with one another using a predetermine logic, to thereby generate the combined keyword group 330 in the keyword list 300. The logic will be described later in detail with reference to FIG. 8.

As described above, the keyword list generating unit 210 may generate the keyword list 300 including the plurality of keyword groups 310, 320, 330, and 340. Specifically, as illustrated in FIG. 3, the keyword list generating unit 210 may generate the keyword group 310 including ‘kid’, ‘child’, and ‘juvenile’, and the keyword group 320 including ‘stock’, ‘estate’, and ‘insurance’ in the keyword list 300, respectively. Also, the keyword list generating unit 210 may generate the keyword group 330 including ‘soccer ball’, ‘soccer shoes’, and ‘soccer clothes’, and the keyword group 340 including ‘footwear’, ‘shoes’, and ‘clothes’ in the keyword list 300, respectively.

Referring again to FIG. 2, the advertisement information determining unit 220 may determine whether keyword-related advertisement information associated with respective keywords included in the content page corresponds to advertisement information of a large advertiser. In this instance, the advertisement information determining unit 220 may determine whether the keyword-related advertisement information corresponds to the advertisement information of the large advertiser, based on address information or content information of the advertisement information.

Specifically, the advertisement information determining unit 220 may determine that the keyword-related advertisement information corresponds to the advertisement information of the large advertiser, when the address information or content information of the keyword-related advertisement information matches the address information or content information of the advertisement information of the large advertiser by more than a predetermined degree. Here, the address information may include a Uniform Resource Locator (URL), that is, address information used for connecting the user with a website of the advertiser when the user clicks on the advertisement information.

The content information may denote text form-data concerning the advertisement information, the advertiser, and commercial items dealt with by the advertiser. The user may readily acquire publicity and marketing information concerning the advertiser or the commercial items by virtue of the content information.

As an example, the advertisement information determining unit 220 may determine that the keyword-related advertisement information corresponds to the advertisement information of the large advertiser, when at least two URLs of the advertisement information match with each other from among advertisement information extracted for the purpose of advertisement display. As another example, the advertisement information determining unit 220 may determine that the keyword-related advertisement information corresponds to the advertisement information of the large advertiser, when at least three content information of the advertisement information match with each other from among advertisement information extracted for the purpose of advertisement display.

The determination unit 230 may determine presence or absence of a relation between respective keywords associated with the advertisement information of the large advertiser, when the keyword-related advertisement information corresponds to the advertisement information of the large advertiser. In this instance, the determination unit 230 may determine the presence and absence of the relation between respective keywords associated with the advertisement information of the large advertiser based on the keyword list. Specifically, the determination unit 230 may determine that the relation between the respective keywords is present, when the respective keywords are included in an identical group of the keyword list. Otherwise, the determination unit 230 may determine that the relation between the respective keywords is absent.

As an example, the keywords associated with the advertisement information of the large advertiser such as ‘kid’, ‘child’, and ‘juvenile’ may be included in an identical group in the keyword list as the example illustrated in FIG. 3. In this case, the determination unit 230 may determine that a relation between the keywords is present. Conversely, keywords associated with the advertisement information of the large advertiser such as ‘kid’, ‘stock’, and ‘soccer ball’ may be included in different groups in the keyword list as the example illustrated in FIG. 3. In this case, the determination unit 230 may determine that a relation between the keywords is absent.

The ranking unit 240 may apply a ranking grade to each of the advertisement information extracted from the database 260 for the purpose of the advertisement display. Here, the ranking grade may be used for determining each position of the advertisement information in the advertisement list. In this instance, the ranking unit 240 may determine the ranking grade with respect to individual advertisement information based on cost per click, cost per advertisement display, a valid click rate, and the like. Also, the ranking unit 240 may sum up an advertisement grade applied considering that keywords are included in the content information of the advertisement information, a default grade applied considering characteristics of the content page, and the like according to characteristics of the contextual adverting, and thereby apply the ranking grade.

The ranking unit 240 may apply a predetermined penalty to at least one of the advertisement information of the large advertiser to thereby update the ranking grade having been applied to the advertisement information of the large advertiser. In this instance, the ranking unit 240 may apply the predetermined penalty to the at least one of the advertisement information of the large advertiser according to the presence or absence of the relation between the keywords associated with the advertisement information of the large advertiser, to thereby update the ranking grade having been applied to the advertisement information of the large advertiser.

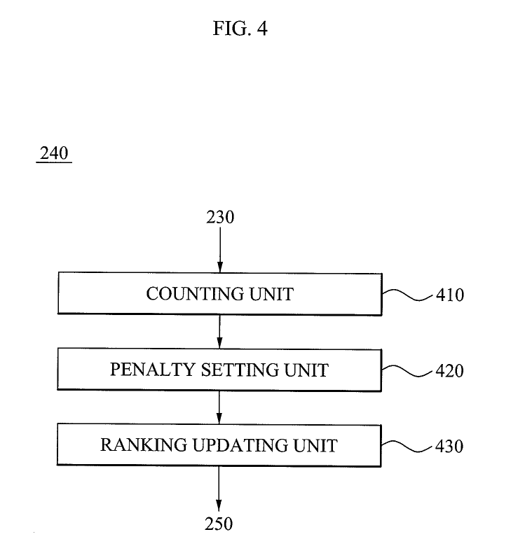

FIG. 4 is a block diagram illustrating an interior configuration of the ranking unit 240 illustrated in FIG. 2. Referring to FIG. 4, the ranking unit 240 may include a counting unit 410, a penalty setting unit 420, and a ranking updating unit 430. The counting unit 410 may count a number of keywords stored in the database 260 in association with the large advertiser. The penalty setting unit 420 may set a predetermined penalty, which is applied to the at least one of the advertisement information of the large advertiser, based on the counted number of the keywords. The ranking updating unit 430 may apply the set penalty to the ranking grade having been applied to the advertisement information of the large advertiser to thereby update a ranking grade of the corresponding advertisement information.

Referring again to FIG. 2, the advertisement list forming unit 250 may arrange the corresponding advertisement information in the advertisement list considering the ranking grade of the updated corresponding advertisement information. Specifically, the advertisement list forming unit 250 may arrange the advertisement information in the advertisement list in a descending order of the ranking grade of the advertisement information. As an example, the advertisement list forming unit 250 may arrange advertisement information ranked as being in the top three in the advertisement list. Also, the advertisement list forming unit 250 may control a predetermined contextual advertising engine, so that the advertisement list is provided together with the content page to the user.

The database 260 may receive, from the advertiser 150 intended to be provided with contextual advertisement services, advertisement information, that is, materials for advertisement publicity and marketing of the advertisers 150, or keywords purchased by the advertiser 150, associate the received advertisement information or keywords with the advertiser 150, and then store the connected information or keywords. Also, the database 260 may store the keyword list generated by the keyword list generating unit 210.

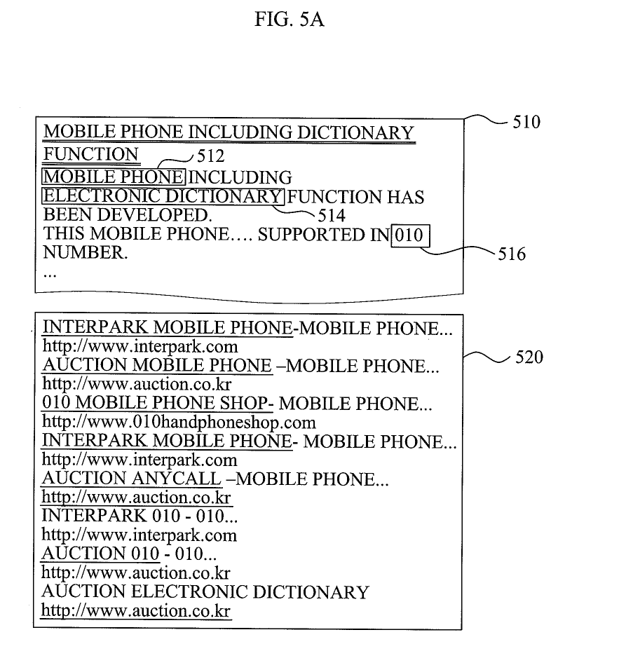

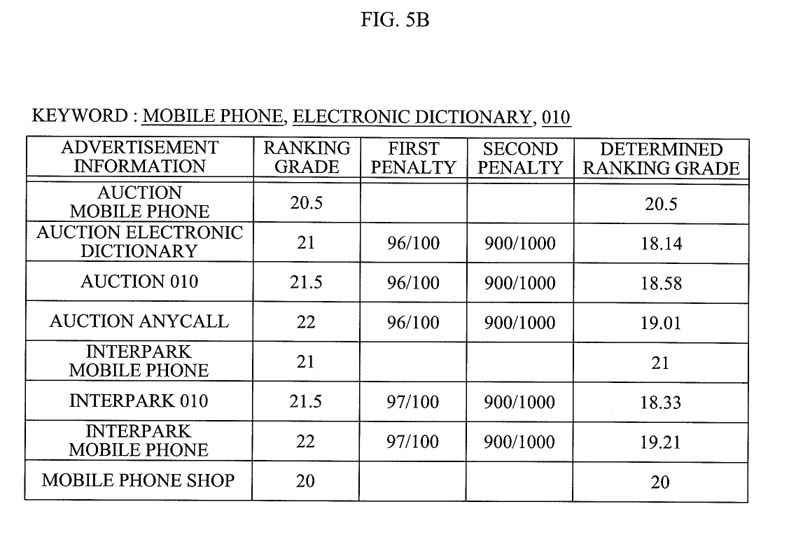

FIGS. 5A and 5B are diagrams illustrating an example of generating an advertisement list in the system for generating the advertisement list according to an embodiment of the present invention.

Referring to FIGS. 2, 5A and 5B, the system 110 may compare keywords 512, 514, and 516 included within keywords purchased by the advertiser in advance and a content page 500, and identify keywords of ‘mobile phone’ 512, ‘electronic dictionary’ 514, and ‘010’ 516 from the content page illustrated in FIG. 5A. Also, the system 110 may search advertisement information concerning the identified keywords from the database 260, and extract, from the searched advertisement information, eight advertisement information of ‘auction mobile phone’, ‘auction electronic dictionary’, ‘auction 010’, ‘auction anycall’, ‘interpark mobile phone’, ‘interpark 010’, ‘interpark mobile phone’, and ‘mobile phone shop’ illustrated in FIG. 5B.

Next, the system 110 may apply a ranking grade to each of the extracted advertisement information, and apply a penalty to each of the ranking grade of the advertisement information corresponding to the advertisement information of the large advertiser. As illustrated in FIG. 5B, the system 110 may sum up an advertisement grade, a default grade, and the like to thereby acquire a ranking grade, and apply the acquired ranking grade to each of the advertisement information. At the same time, the system 110 may multiply a first penalty of ‘96/100’ by a ranking grade of ‘auction 010’ and ‘auction anycall’, respectively, from among ‘auction mobile phone’, ‘auction 010’, and ‘auction anycall’ which are determined as keywords associated with each other of the advertisement information of the large advertiser, and multiply another first penalty of ‘97/100’ by a ranking grade of ‘interpark 010’ and ‘interpark mobile phone’, respectively, from among ‘interpark mobile phone’, ‘interpark 010’, and ‘interpark mobile phone’, thereby updating a ranking grade having been applied to the advertisement information of the large advertiser.

Also, in one embodiment, the system 110 may multiply the other first penalty of ‘97/100’ by a ranking grade ‘auction electronic dictionary’ which are determined as keywords not associated with each other of the advertisement information of the large advertiser, thereby updating a ranking grade having been applied to the advertisement information of the large advertiser. In another embodiment, a penalty is not multiplied to the ranking grade ‘auction electronic dictionary’.

In determination of the large advertiser, the system 110 may compare addresses of the extracted advertisement information with one another, and recognize ‘auction mobile phone’, ‘auction 010’, ‘auction anycall’, and ‘auction electronic dictionary’ of advertisement information, each having an identical Uniform Resource Locator (URL), that is, ‘www.auction.co.kr’ as advertisement information associated with ‘auction’ of the large advertiser. Also, the system 110 may compare addresses of the extracted advertisement information, and recognize ‘interpark mobile phone’, ‘interpark 010’, and ‘interpark mobile phone’, each having an identical address information, that is, ‘www.interpark.com’ as advertisement information associated with ‘interpark’ of the large advertiser.

In determining the first penalty, the system 110 may recognize four advertisement information associated with ‘auction’ from among the extracted advertisement information, and apply another first penalty of ‘96/100’ corresponding to the number of the recognized advertisement information to the advertisement information associated with ‘auction’. Also, the system 110 may recognize three advertisement information associated with ‘interpark’ from among the extracted advertisement information, and apply the other first penalty of ‘97/100’ corresponding to the recognized advertisement information to the advertisement information associated with ‘interpark’. The system 110 may allow an operator to flexibly set the first penalty taking into consideration a system environment.

Next, the system 10 may count a total number of keywords purchased by the large advertiser in the database 260, and apply, to a ranking grade, a second penalty determined based on the counted number. For example, when the total number of keywords registered (stored) in the database 260 with ‘auction’ of the large advertiser for the purpose of contextual advertisement is counted as 100, the system 110 may apply a second penalty of ‘900/1000’ to the advertisement information associated with ‘auction’, based on the counted number. Also, when the total number of keywords registered (stored) in the database 260 by ‘interpark’ of the large advertiser for the purpose of contextual advertisement is counted as ‘100’, the system 10 may apply a second penalty of ‘900/1000’ to the advertisement information associated with ‘interpark’. The system 110 may allow the operator to flexibly set the second penalty taking into consideration a system environment.

Accordingly, the system 110 may apply the first and second penalties to the advertisement information of the large advertiser, thereby reducing the ranking grade of the corresponding advertisement information. For example, as illustrated in FIGS. 5A and 5B, the system 110 may arrange the advertisement information in the advertisement list in a descending order of the ranking grade based on the updated ranking grade. Specifically, ‘interpark mobile phone’, ‘auction mobile phone’, and ‘interpark mobile phone’ of the advertisement information may be arranged in the advertisement list in the stated order.

Thus, the system for generating the advertisement list of embodiments may improve the contextual advertising such that advertisement information of the large advertiser is exclusively obtained regardless of contents of the content page and the searched advertisement information is displayed to a user. Specifically, the system for generating the advertisement list of an embodiment may suppress the so-called ‘rich get richer, poor get poorer’ phenomenon concerning advertisement display in which advertisement information of small and medium advertisers is difficult to be displayed to users, thereby preventing advertisement information of the large advertiser from being exclusively displayed in the advertisement list regardless of contents of the content page, and thus enhancing advertisement display opportunities of the small and medium advertisers.

In addition, the system and method for generating the advertisement list according to an embodiment of the present invention may appropriately apply a penalty to advertisement information of the large advertiser, thereby preventing reverse discrimination against the advertisement information of the large advertiser from occurring due to the penalty applied to the ranking grade.

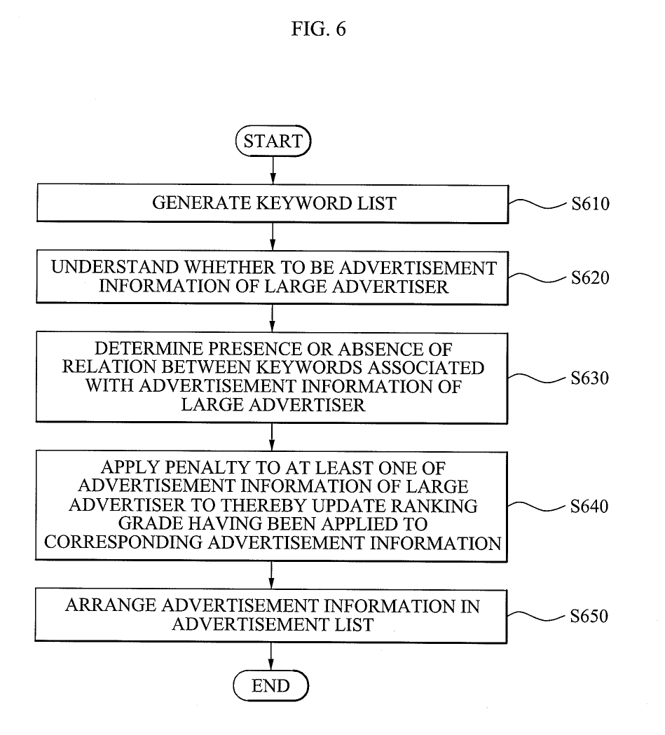

FIG. 6 is a flowchart illustrating a method for generating an advertisement list according to an embodiment of the present invention. Referring to FIGS. 2 and 6, in operation S610, the method for generating the advertisement list according to an embodiment may combine keywords associated with each other from among keywords included in the content page to thereby generate a plurality of keyword groups in the keyword list. Specifically, the system 110 may (1) associate the keywords with one another using at least one of a dictionary meaning, a category, or a predetermined logic, (2) combine the associated keywords to thereby generate the plurality of keyword groups in the keyword list, and (3) form the generated plurality of keyword groups into the keyword list, thereby generating the keyword list.

An example of the keyword list generated through the above described process is illustrated in FIG. 3. The keyword list has been already described in detail in FIG. 3, and thus detailed descriptions thereof will be herein omitted. In operation S620, the system 110 may determine whether the keyword-related advertisement information associated with respective keywords included in the content page corresponds to advertisement information of the large advertiser. In this instance, the system 110 may determine whether the keyword-related advertisement information corresponds to the advertisement information of the large advertiser based on each of address information or content information of the advertisement information of the large advertiser and keyword-related advertisement information.

Specifically, the system 110 may determine that the keyword-related advertisement information corresponds to the advertisement information of the large advertiser, when address information or content information of the keyword-related advertisement information matches address information or content information of the advertisement information of the large advertiser by more than a predetermined degree. Here, the address information may include the URL, that is, address information used for inducing the user to connect with a website concerning the advertiser when the user clicks on the advertisement information. The content information may denote text form-data concerning the advertisement information, the advertiser, and commercial items dealt with by the advertiser. The user may readily acquire publicity and marketing information concerning the advertiser or the commercial items by virtue of the content information.

As an example, the system 110 may determine that the keyword-related advertisement information corresponds to the advertisement information of the large advertiser, when at least two URLs of the advertisement information match with each other from among advertisement information extracted for the purpose of advertisement display. As another example, the system 110 may determine that the keyword-related advertisement information corresponds to the advertisement information of the large advertiser, when at least three content information of the advertisement information match with each other from among advertisement information extracted for the purpose of advertisement display.

In operation S630, the system 110 may determine presence or absence of a relation between keywords associated with the advertisement information of the large advertiser, when determine that the keyword-related advertisement information corresponds to the advertisement information of the large advertiser. In this instance, the system 110 may determine presence or absence of the relation between the keywords based on the keyword list. Specifically, the system 110 may determine that the relation between the keywords is present when the keywords are included in an identical group of the keyword list. Conversely, the system 110 may determine that the relation between the keywords is absent when the keywords are included in different groups of the keyword list.

As an example, the keywords associated with the advertisement information of the large advertiser such as ‘kid’, ‘child’, and ‘juvenile’ may be included in an identical group in the keyword list as the example illustrated in FIG. 3. In this case, the system 110 may determine that the relation between the keywords is present. Conversely, the keywords associated with the advertisement information of the large advertiser such as ‘kid’, ‘stock’, and ‘soccer ball’ may be included in different groups in the keyword list as the example illustrated in see FIG. 3. In this case, the determination unit 230 may determine that the relation between the keywords is absent.

The system 110 may apply a ranking grade to each of the advertisement information extracted from the database 260 for the purpose of advertisement display. Here, the ranking grade may be used for determining each position of the advertisement information in the advertisement list. In this instance, the system 110 may determine the ranking grade with respect to individual advertisement information based on cost per click, cost per advertisement display, a valid click rate, and the like. Also, the system 110 according to an embodiment may sum up an advertisement grade applied considering that keywords are included in the content information of the advertisement information, a default grade applied considering characteristics of the content page, and the like according to characteristics of the contextual adverting, and thereby apply the ranking grade.

In operation S640, the system 110 may apply a predetermined penalty to at least one of advertisement information of the large advertiser to thereby update a ranking grade having been applied to the advertisement information of the large advertiser. In this instance, the system 110 may apply the predetermined penalty to at least one of the advertisement information of the large advertiser according to the presence or absence of the relation between the keywords associated with the advertisement information of the large advertiser, thereby updating the ranking grade having been applied to the advertisement information of the large advertiser.

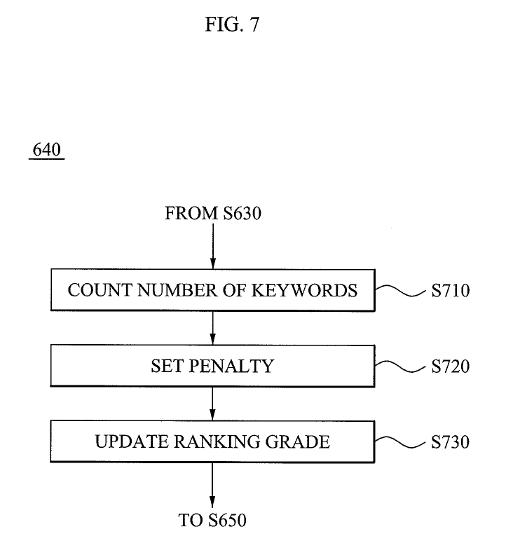

FIG. 7 is a flowchart illustrating a process where a penalty is applied to advertisement information of a large advertiser according to an embodiment of the invention. Referring to FIGS. 2 and 7, operation S640 may include operations S710, S720, and S730. Specifically, in operation S710, the system 110 may count a number of keywords stored in the database 260 in association with the large advertiser. In operation S720, the system 110 may set the predetermined penalty to the at least one of the advertisement information of the large advertiser based on the counted number of the keywords. In operation S730, the system 110 may apply the set penalty to the ranking grade having been applied to the corresponding advertisement information of the large advertiser to thereby update the ranking grade of the corresponding advertisement information.

Referring again to FIGS. 2 and 6, in operation S650, the system 110 may arrange the corresponding advertisement information in the advertisement list based on the ranking grade of the updated advertisement information. Specifically, the system 110 may arrange the advertisement information in the advertisement list in a descending order of a ranking grade of the advertisement information extracted for the purpose of advertisement display. As an example, the system 110 may arrange advertisement information ranked as being in the top three in the advertisement list. Also, the system 110 may control a predetermined contextual advertising engine, so that the advertisement list and the content page are provided to a user.

FIG. 8 is a flowchart illustrating a process where reliability between keywords is measured according to an embodiment of the invention. Referring to FIGS. 2 and 8, in operation S810, the system 110 may acquire keyword statistical information using the keywords included in the content page. In this instance, the system 110 may measure a number of times the keywords are displayed in the content page for each keyword, that is, an display frequency, and a number of content pages where the keywords are displayed together with other keywords, that is, a cross frequency. Next, the system 110 may generate frequency information based on the display frequency and the cross frequency, and acquire the display frequency, the cross frequency, or the frequency information acting as the keyword statistical information.

In operation S820, the system 110 may standardize the acquired keyword statistical information. In this instance, the system 110 may standardize the acquired keyword statistical information into at least one of multidimensional vectors, real-valued random variables, joint probability distribution of random variables, or discrete random variables. In operation S830, the system 110 may measure relevance between the keywords based on the standardized keyword statistical information. In this instance, the system 110 may calculate at least one of Lₚ of inverse, cosine coefficient, extended Jaccard's coefficient, and correlation with respect to two vectors of multidimensional vectors, and the calculated values may be used for measuring the relevance between the keywords.

Also, the system 110 may calculate at least one of Jaccard's coefficient, dice's coefficient, odds-ratio, mutual information, and point-wise mutual information with respect to two random variables of the real-valued random variables using the joint probability distribution, and the calculated values may be used for measuring the relevance between the keywords.

Also, the system 110 may measure f(w|v) of the relevance between the keywords using

f(w|v)=p(w|v)−C1·p*(w)·(1+0.01/(C2+p*(w))). [Equation 1]

Here, the relevance between the keywords may be regarded as ‘0’, when the relevance is less than ‘0’. In this instance, p*(W) denotes the sum total of p(w|v)p(v) with respect to ‘v’ of all keywords, p(v) denotes a ratio with respect to the sum of a content page frequency (with respect to ‘v’) and a content page frequency (with respect to ‘k’), and k denotes all keywords.

The method for generating the advertisement list according to the above-described embodiments of the present invention may be recorded in computer-readable media including program instructions to implement various operations embodied by a computer. The media may also include, alone or in combination with the program instructions, data files, data structures, and the like. The media and program instructions may be those specially designed and constructed for embodiments of the present invention, or they may be of the kind well-known and available to those having skill in the computer software arts. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

As to the method and system for generating the advertisement list according to embodiments of the invention, in the case where advertisement information associated with respective keywords included in the content page corresponds to advertisement information of a large advertiser, when a relation between respective keywords associated with the advertisement information of the large advertiser is present based on a keyword list including a plurality of keyword groups acquired by combining keywords associated with each other, a predetermined penalty may be applied to at least one of the advertisement information of the large advertiser to thereby update a ranking grade having been applied to the advertisement information of the large advertiser, and arrange the keyword-related advertisement information in an advertisement list based on the updated ranking.

As a result, a contextual advertising scheme in which the advertisement information of the large advertiser is exclusively obtained and displayed to users regardless of contents of the content page may be solved. Specifically, a ‘rich get richer, poor get poorer’ phenomenon concerning advertisement display may be suppressed, in which advertisement information of small and medium advertisers is difficult to be displayed to users, thereby preventing the advertisement information of the large advertiser from being exclusively displayed in an advertisement list regardless of contents of a content page for the purpose of an display to users, and thus enhancing advertisement display opportunities of the small and medium advertisers.

Also, in the method and system for generating the advertisement list according to embodiments of the invention, a penalty may be appropriately applied to the advertisement information of the large advertiser, thereby preventing reverse discrimination against the advertisement information of the large advertiser from occurring due to the penalty.

As described above, according to an embodiment of the present invention, the so-called ‘rich get richer, poor get poorer’ phenomenon concerning advertisement display is suppressed, in which advertisement information of small and medium advertisers is difficult to be displayed to users, thereby preventing advertisement information of a large advertiser from being exclusively displayed in an advertisement list regardless of contents of a content page for the purpose of an display to users, and thus enhancing advertisement display opportunities of the small and medium advertisers.

According to an embodiment of the present invention, a penalty is appropriately applied to the advertisement information of the large advertiser, thereby preventing reverse discrimination against the advertisement information of the large advertiser from occurring due to the penalty.

According to an embodiment of the present invention, advertisers are divided according to relevance between keywords, thereby preventing characteristics of advertisement groups from being wholly undistinguished due to a large advertiser having relatively many advertisements.

According to an embodiment of the present invention, an advertiser enabling a plurality of advertisement information, which has a relatively high relevance between keywords, to be included in the advertisement list is precisely identified as the large advertiser based on the relevance between the keywords of the advertisement information included in the advertisement list, thereby reliably applying a penalty with respect to the large advertiser.

Although embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A method of formulating a list of advertisements in an advertisement service, the method comprising:
analyzing a web content so as to identify a plurality of keywords therefrom;
retrieving data of a plurality of advertisements, each of which is associated with one of the plurality of keywords and is presently subject to an advertising service;
processing the data of the plurality of advertisements so as to identify two or more advertisements that are associated with the same advertiser;
further processing data of the two or more advertisements so as to identify at least one qualified advertisement for disfavoring in the advertising service; and
ordering at least part of the plurality of advertisements to display along with the web content such that the at least one qualified advertisement is disfavored in the ordering.

2. The method of claim 1, wherein each advertisement data comprises at least one selected from the group consisting of a keyword, information of an advertiser, a web address that is to be anchor-tagged, and a description of the advertisement to be displayed with an anchor tag of the web page.

3. The method of claim 2, wherein two or more advertisements are identified as associated with the same advertiser when said two or more advertisements have an identical description.

4. The method of claim 2, wherein two or more advertisements are identified as associated with the same advertiser when said two or more advertisements have a common portion in their web addresses.

5. The method of claim 2, wherein two or more advertisements are identified as associated with the same advertiser when said two or more advertisements have an identical web address.

6. The method of claim 1, wherein further processing comprises analyzing the keywords of the two or more advertisements.

7. The method of claim 6, wherein at least one of the two or more advertisements is identified as qualified for disfavoring when at least two keywords of the two or more identified advertisements belong to a single category among a plurality of predetermined categories.

8. The method of claim 6, wherein at least one of the two or more advertisements is identified as qualified for disfavoring when at least two keywords of the two or more identified advertisements are synonyms.

9. The method of claim 6, wherein at least one of the two or more advertisements is identified as qualified for disfavoring when two keywords of the two or more identified advertisements is determined as related from a statistical processing using data of appearances of keywords in web contents.

10. The method of claim 1, wherein the at least one qualified advertisement is disfavored based on a disfavoring factor computed using the number of advertisements having an identical description among the plurality of advertisements, wherein the higher the number is, the higher the disfavoring factor is.

11. The method of claim 1, wherein the at least one qualified advertisement is disfavored based on a disfavoring factor computed using the number of advertisements having a common portion in their web addresses among the plurality of advertisements, wherein the higher the number is, the higher the disfavoring factor is.

12. The method of claim 1, wherein the at least one qualified advertisement is disfavored based on a disfavoring factor computed using the number of advertisements having an identical web address among the plurality of advertisements, wherein the higher the number is, the higher the disfavoring factor is.

13. The method of claim 1, wherein the at least one qualified advertisement is disfavored based on a disfavoring factor computed using the number of advertisements having an identical keyword among the plurality of advertisements, wherein the higher the number is, the higher the disfavoring factor is.

14. The method of claim 1, wherein the at least one qualified advertisement is disfavored based on a disfavoring factor computed using the number of advertisements having keywords that are synonyms among the plurality of advertisements, wherein the higher the number is, the higher the disfavoring factor is.

15. The method of claim 1, wherein the at least one qualified advertisement is disfavored based on a disfavoring factor computed using the number of advertisements having keywords that belong to a single category among a plurality of predetermined categories among the plurality of advertisements, wherein the higher the number is, the higher the disfavoring factor is.

16. The method of claim 1, wherein the at least one qualified advertisement is disfavored based on a disfavoring factor computed using the number of advertisements of the same advertiser among the total advertisements that are presently subject to the advertising service, wherein the higher the number is, the higher the disfavoring factor is.

17. The method of claim 1, wherein ordering at least part of the plurality of advertisements comprises:
computing a ranking index for each of at least part of the plurality of advertisements; and
sorting at least part of the plurality of advertisements using the ranking index.

18. The method of claim 17, wherein computing the ranking index comprises using a formula comprising a favoring factor and a disfavoring factor, wherein the at least one qualified advertisement has a non-zero value of the disfavoring factor in computing the ranking index.

19. The method of claim 18, wherein the favoring factor comprises at least one selected from the group consisting of a cost-per-click for each advertisement, wherein the higher the cost-per-click is, the higher favoring factor is.

20. The method of claim 18, wherein the favoring factor comprises at least one selected from the group consisting of a cost-per-click for each advertisement, the number of click-throughs for each advertisement for a time period, wherein the higher the number of click-throughs, the higher the favoring factor is.

21. The method of claim 18, wherein the favoring factor comprises at least one selected from the group consisting of a cost-per-click for each advertisement, relatedness of a advertisement content of each advertisement to a keyword of the advertisement, wherein the more the relatedness is, the higher the favoring factor is.

22. The method of claim 1, wherein ordering at least part of the plurality of advertisements comprises:
computing a ranking index for each of at least part of the plurality of advertisements using at least one ranking factor selected from the group consisting of a cost-per-click for each advertisement, the number of click-throughs for each advertisement for a time period, relatedness of a advertisement content of each advertisement to a keyword of the advertisement; and
adjusting the ranking index using a disfavoring factor for the at least one qualified advertisement.

23. A system for formulating a list of advertisements in an advertisement service, the method comprising:
means for identifying a plurality of keywords therefrom;
means for providing data of a plurality of advertisements, each of which is associated with one of the plurality of keywords and is presently subject to an advertising service;
means for processing the data of the plurality of advertisements so as to identify two or more advertisements that are associated with the same advertiser and further processing data of the two or more advertisements so as to identify at least one qualified advertisement for disfavoring in the advertising service; and
means for ordering at least part of the plurality of advertisements to display along with the web content such that the at least one qualified advertisement is disfavored in the ordering.
